(19) United States
(12) Patent Application Publication
(10) Pub. No.: US 2026/0073824 A1
(43) Pub. Date: Mar. 12, 2026

(54) ELECTRONIC DEVICE

(71) Applicant: InnoLux Corporation, Miao-Li County (TW)

(72) Inventors: Hung-Sheng LIAO, Miao-Li County (TW); Min-Hsin LO, Miao-Li County (TW); Ming-Chun TSENG, Miao-Li County (TW)

(21) Appl. No.: 19/296,305

(22) Filed: Aug. 11, 2025

Related U.S. Application Data
(60) Provisional application No. 63/693,500, filed on Sep. 11, 2024.

(30) Foreign Application Priority Data
Mar. 27, 2025 (CN) 202510371369.1

(51) Int. Cl. G09G 3/00; G09G 3/3233

(52) U.S. Cl. CPC G09G 3/006; G09G 3/3233; G09G 2310/08; G09G 2330/12

(57) ABSTRACT

An electronic device includes a substrate, and a first electronic component, a second electronic component, a first switch transistor and a shared electric pad arranged on the substrate. The first switch transistor is coupled to the first electronic component and the second electronic component. The shared electric pad is coupled to the first electronic component and the second electronic component respectively through the first switch transistor. When the first switch transistor is on, the electrical properties of the first electronic component and the second electronic component can be measured from the shared electric pad. When the first switch transistor is off, the electrical properties of the first electronic component and the second electronic component cannot be measured from the shared electric pad.

### CROSS-REFERENCE TO RELATED APPLICATIONS

This application claims the benefit of filing date of U.S. Provisional Application Ser. No. 63/693,500 filed on Sep. 11, 2024 under 35 USC § 119 (e) (1), and also claims the benefit of the Chinese Patent Application Serial Number 202510371369.1, filed on Mar. 27, 2025, the subject matters of which are incorporated herein by reference.

### BACKGROUND

### Field of the Disclosure

The present disclosure relates to an electronic device and, more particularly, to an electronic device capable of performing electrical property measurements.

### Description of Related Art

In electronic devices, due to the demand for high-density configuration, the layout area of the electronic devices may become smaller and smaller. In order to test the electronic devices, corresponding test pads are required. However, if the electronic devices are occupied by a large number of test pads, it is not conducive to the layout of the electronic devices and thus needs to be improved.

Therefore, there is an urgent need to provide a novel electronic device to alleviate and/or obviate the aforementioned problems.

### SUMMARY

The present disclosure provides an electronic device, which includes: a substrate; a first electronic component and a second electronic component disposed on the substrate; a first switch transistor disposed on the substrate and coupled to the first electronic component and the second electronic component; and a shared electric pad disposed on the substrate and coupled to the first electronic component and the second electronic component respectively through the first switch transistor, wherein, when the first switch transistor is turned on, electrical properties of the first electronic component and the second electronic component can be measured separately from the shared electric pad, and when the first switch transistor is turned off, electrical properties of the first electronic component and the second electronic component cannot be measured separately from the shared pad.

The present disclosure further provides an electronic device, which includes: a substrate; a first electronic component and a second electronic component disposed on the substrate; a first switch transistor and a second switch transistor disposed on the substrate, wherein the first switch transistor is coupled to the first electronic component, and the second switch transistor is coupled to the second electronic component; and a shared electric pad disposed on the substrate, coupled to the first electronic component through the first switch transistor, and coupled to the second electronic component through the second switch transistor, wherein, when the first switch transistor and the second switch transistor are respectively turned on, electrical properties of the first electronic component and the second electronic component are measured separately from the shared electric pad, and when the first switch transistor and the second switch transistor are respectively turned off, electrical properties of the first electronic component and the second electronic component cannot be measured separately from the shared electric pad.

Other novel features of the disclosure will become more apparent from the following detailed description when taken in conjunction with the accompanying drawings.

### BRIEF DESCRIPTION OF DRAWINGS

FIG. 1 schematically illustrates a circuit structure and a circuit timing of an electronic device according to an embodiment of the present disclosure;

FIG. 2 schematically illustrates another circuit structure of an electronic device according to an embodiment of the present disclosure;

FIG. 3 schematically illustrates a circuit structure and a circuit timing of an electronic device according to another embodiment of the present disclosure;

FIG. 4 schematically illustrates a circuit structure of an electronic device according to another embodiment of the present disclosure;

FIG. 5 schematically illustrates a circuit structure and a circuit timing diagram of an electronic device according to another embodiment of the present disclosure;

FIG. 6 schematically illustrates a circuit structure of an electronic device according to another embodiment of the present disclosure;

FIG. 7 schematically illustrates a circuit structure and a circuit timing diagram of an electronic device according to another embodiment of the present disclosure;

FIG. 8 schematically illustrates a circuit structure of an electronic device according to another embodiment of the present disclosure;

FIG. 9 schematically illustrates a circuit structure and a timing diagram of an electronic device according to another embodiment of the present disclosure;

FIG. 10 illustrates a measurement architecture of the electronic device of the present disclosure using a contact-type shared electric pad; and

FIG. 11 illustrates a measurement architecture of the electronic device of the present disclosure using a non-contact shared electric pad.

### DETAILED DESCRIPTION OF EMBODIMENT

fferent embodiments of the present disclosure are provided in the following description. These embodiments are meant to explain the technical content of the present disclosure, but not meant to limit the scope of the present disclosure. A feature described in an embodiment may be applied to other embodiments by suitable modification, substitution, combination, or separation.

It should be noted that, in the present specification, when a component is described to “comprise”, “have”, “include” an element, it means that the component may include one or more of the elements, and the component may include other elements at the same time, and it does not mean that the component has only one of the element, except otherwise specified.

Moreover, in the present specification, the ordinal numbers, such as “first” or “second”, are only used to distinguish a plurality of elements having the same name, and it does not means that there is essentially a level, a rank, an executing order, or an manufacturing order among the elements, except otherwise specified. The ordinal numbers of the elements in the specification may not be the same in claims. For example, a “second” element in the specification may be a “first” element in the claims.

In the present specification, except otherwise specified, the feature A “or” or “and/or” the feature B means only the existence of the feature A, only the existence of the feature B, or the existence of both the features A and B. The feature A “and” the feature B means the existence of both the features A and B.

Moreover, in the present specification, the terms, such as “top”, “upper”, “bottom”, “front”, “back”, or “middle”, as well as the terms, such as “on”, “above”, “over”, “under”, “below”, or “between”, are used to describe the relative positions among a plurality of elements, and the described relative positions may be interpreted to include their translation, rotation, or reflection.

Furthermore, the terms recited in the specification and the claims such as “above”, “over”, “on”, “below”, or “under” are intended that an element may not only directly contacts other element, but also indirectly contact the other element.

Furthermore, the term recited in the specification and the claims such as “connect” is intended that an element may not only directly connect to other element, but also indirectly connect to other element. On the other hand, the terms recited in the specification and the claims such as “electrically connected” and “coupled” are intended that an element may not only directly electrically connect to other element, but also indirectly electrically connect to other element.

In this disclosure, the term “almost”, “about”, “approximately” or “substantially” usually means within 20%, 10%, 5%, 3%, 2%, 1% or 0.5% of a given value or range. The quantity the given value is an approximate quantity, which means that the meaning of “almost”, “about”, “approximately” or “substantially” may still be implied in the absence of a specific description of “almost”, “about”, “approximately” or “substantially”. In addition, the terms “range is a first value to a second value” and “range is between a first value and a second value” mean that the range includes the first value, the second value and other values between the first value and the second value.

In the present disclosure, the thickness, length and width can be measured by using an optical microscope, and the thickness can be measured by the cross-sectional image in an electron microscope, but it is not limited thereto. In addition, there may be a certain error in any two values or directions used for comparison. If the first value is equal to the second value, it implies that there may be an error of about 10% between the first value and the second value. If the first direction is perpendicular to the second direction, the angle between the first direction and the second direction may be 80 to 100 degrees. If the first direction is parallel to the second direction, the angle between the first direction and the second direction may be −10 to 10 degrees.

In the present specification, except otherwise specified, the terms (including technical and scientific terms) used herein have the meanings generally known by a person skilled in the art. It should be noted that, except otherwise specified in the embodiments of the present disclosure, these terms (for example, the terms defined in the generally used dictionary) should have the meanings identical to those skilled in the art, the background of the present disclosure or the context of the present specification, and should not be read by an ideal or over-formal way.

In addition, the electronic device disclosed in the present disclosure may include a display device, a backlight device, an antenna device, a sensing device or a tiled device, but not limited thereto. The electronic device may be a bendable or flexible electronic device. The display device may be a non-self-luminous display device or a self-luminous display device. The antenna device may be a liquid crystal type antenna device or a non-liquid crystal type antenna device. The sensing device may be a sensing device that senses capacitance, light, heat energy or ultrasonic waves, but not limited thereto. The electronic components may include passive components and active components, such as capacitors, resistors, inductors, diodes, transistors, etc. The diodes may include light emitting diodes or photodiodes. The light emitting diode may include, for example, an organic light emitting diode (OLED), a sub-millimeter light emitting diode (mini LED), a micro light emitting diode (micro LED) or a quantum dot light emitting diode (quantum dot LED), but not limited thereto. The tiled device may be, for example, a display tiled device or an antenna tiled device, but not limited thereto. It should be noted that the electronic device may be any combination of the above, but not limited thereto.

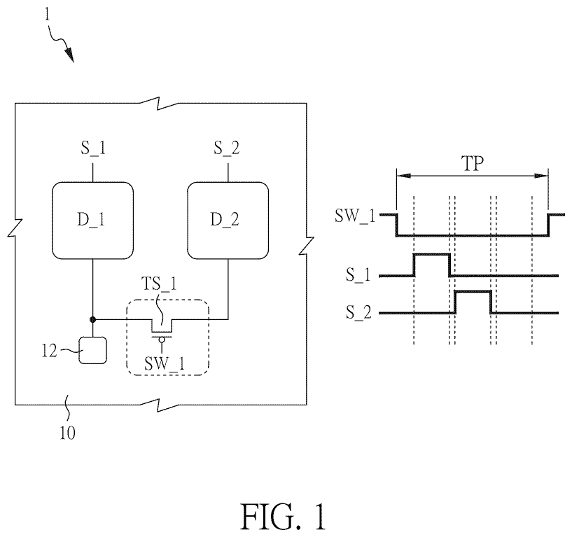

Please refer to FIG. 1, which schematically illustrates a circuit structure and a circuit timing of an electronic device according to an embodiment of the present disclosure. As shown in the circuit structure of FIG. 1, the electronic device 1 includes a substrate 10 and a circuit unit arranged on the substrate 10. For the convenience of description, FIG. 1 is a schematic diagram showing one circuit unit of the electronic device 1, while omitting the illustration of the remaining circuit units. The circuit unit of the electronic device 1 includes an electronic component D_1, an electronic component D_2, a switch transistor TS_1 and a shared electric pad 12. The electronic component D_1 and the electronic component D_2 are disposed on the substrate 10, wherein the electronic components (D_1, D_2) may include passive components and/or active components, such as capacitors, resistors, inductors, diodes, transistors, ICs, other appropriate components, and circuits including the above components. The switch transistor TS_1 is disposed on the substrate 10 and coupled to the electronic component D_1 and the electronic component D_2. More specifically, the control end of the switch transistor TS_1 is connected to a switch signal SW_1, and the two connection ends of the switch transistor TS_1 are respectively coupled to the electronic component D_1 and the electronic component D_2. The shared electric pad 12 is disposed on the substrate 10 and is coupled to the electronic component D_1 and the electronic component D_2 through the switch transistor TS_1. More specifically, the shared electric pad 12 is coupled to the electronic component D_1 and selectively coupled to the electronic component D_2 according to the control of the switch transistor TS_1. Accordingly, since multiple electronic components D_1, D_2 share a single switch transistor TS_1 and the output positions of the electronic components D_1, D_2 are separated by the switch transistor TS_1, the output signals may be conveniently monitored using a single switch transistor TS_1 and a single shared electric pad 12, thereby optimizing the layout area and saving testing time.

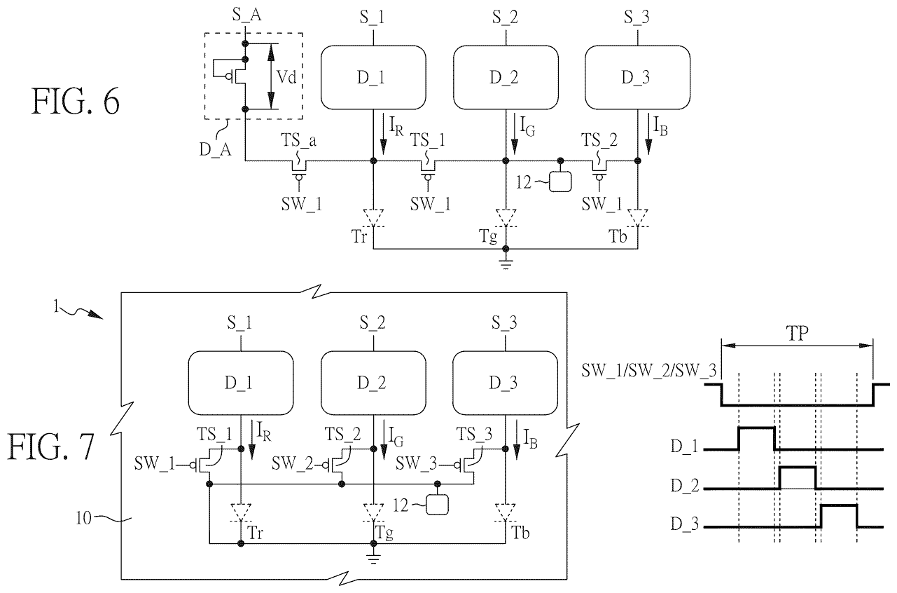

With the above circuit structure, when the switch transistor TS_1 is turned on (ON), the electrical properties of the electronic component D_1 and the electronic component D_2 can be measured separately from the shared electric pad 12. When the switch transistor TS_1 is turned off (OFF), the electrical properties of the electronic component D_1 and the electronic component D_2 cannot be measured separately from the shared electric pad 12. For example, referring to the circuit timing of FIG. 1, the on or off state of the switch transistor TS_1 is controlled by the switch signal SW_1; that is, in the present disclosure, the switch signal SW_1 is used to control the state of the switch transistor TS_1 to ensure that the switch transistor TS_1 is activated during the measurement period and kept off at other times. In the present embodiment, since the switch transistor TS_1 is an N-type transistor, when the switch signal SW_1 is at a low level (representing logic 0, for example), the switch transistor TS_1 is turned on. Conversely, when the switch signal SW_1 is at a high level (representing logic 1, for example), the switch transistor TS_1 is turned off. However, this is only an example but not a limitation. It is conceivable that the switch transistor TS_1 may be a P-type transistor or another suitable type of transistor. Therefore, as shown in the circuit timing of FIG. 1, during the period TP when the switch transistor TS_1 is turned on, the shared electric pad 12 is coupled to the electronic component D_1 and the electronic component D_2, respectively, and during this period TP, an input signal S_1 may be applied to the electronic component D_1 and an input signal S_2 may be applied to the electronic component D_2, wherein the input signal S_1 and the input signal S_2 do not overlap in time. Since the shared electric pad 12 is coupled to the electronic component D_1 and the electronic component D_2, when the input signal S_1 is applied to the electronic component D_1, the output of the electronic component D_1 may be obtained, and the electrical properties of the electronic component D_1 can be measured from the shared electric pad 12. When the input signal S_2 is applied to the electronic component D_2, the output of the electronic component D_2 may be obtained, and the electrical properties of the electronic component D_2 can be measured from the shared electric pad 12. When the switch transistor TS_1 is turned off, the shared electric pad 12 is not coupled to the electronic component D_2 and no input signal S_1, S_2 is applied to the electronic components D_1, D_2. Therefore, the electrical properties of the electronic components D_1 and D_2 cannot be measured from the shared electric pad 12. With this circuit architecture, it is able to provide an optimized measurement framework, which is suitable for performing a test in contact with the shared electric pad 12, and is also suitable for performing a test without contacting the shared electric pad 12 (shown in FIG. 6), and may be applied to various types of circuits.

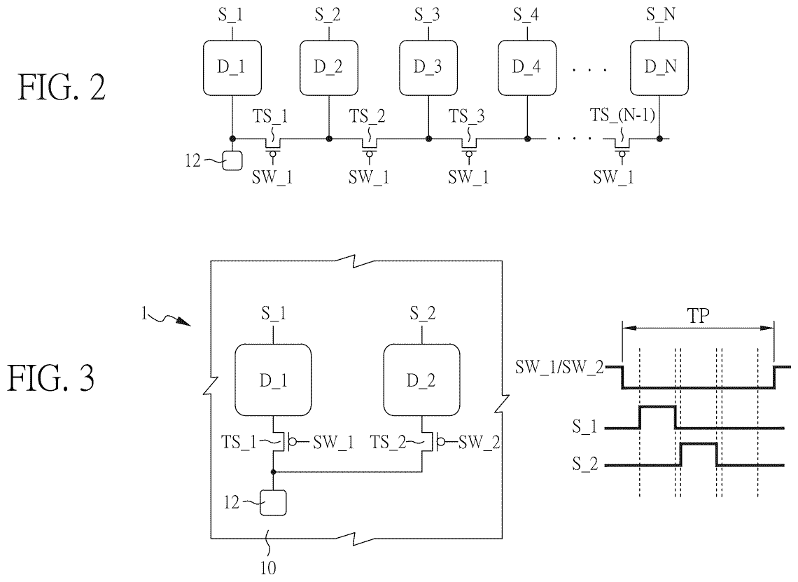

In addition, although the circuit unit shown in FIG. 1 has two electronic components (D_1, D_2), the present disclosure is not limited thereto. Please refer to FIG. 2, which schematically illustrates another circuit structure of an electronic device according to an embodiment of the present disclosure, wherein the architecture of the circuit unit of the electronic device 1 in FIG. 2 is similar to that in FIG. 1, but has N electronic components D_1˜D_N and (N−1) switch transistors TS_1˜TS_N−1 (wherein the electronic component D_1 and the electronic component D_2 of the previous embodiment may be regarded as included in the N electronic components D_1˜D_N of the this embodiment, and the switch transistor TS_1 of the previous embodiment may be regarded as included in the (N−1) switch transistors TS_1˜TS_N−1 of the this embodiment), where N is an integer greater than or equal to 2 (N≥2). The control ends of (N−1) switch transistors TS_1˜TS_N−1 are each connected to the switch signal SW_1, and the switch transistor TS_i is coupled to the electronic component D_i and the electronic component D_i+1, where i is an integer and i=1˜(N−1). The shared electric pad 12 is coupled to the electronic components D_1˜D_N respectively through switch transistors TS_1˜TS_N−1.

With the above circuit architecture, when the switch signal SW_1 controls the switch transistors TS_1˜TS_N−1 to be turned on, input signals S_1˜S_N are applied to the electronic components D_1˜D_N, respectively, wherein the input signals S_1˜S_N do not overlap each other in time. When the input signal S_i is applied to the electronic component D_i, the output of the electronic component D_i may be obtained, and the electrical properties of the electronic component D_i can be measured from the shared electric pad 12, wherein i is an integer and i=1˜N, so that the test of the electronic components D_1˜D_N may be achieved. When the switch signal SW_1 controls the switch transistors TS_1˜TS_N−1 to be turned off, the shared electric pad 12 is not coupled to the electronic components D_2˜D_N, and no input signal S_1˜S_N is applied to the electronic components D_1˜D_N. Therefore, the electrical properties of the electronic components D_1˜D_N cannot be measured from the shared electric pad 12. In addition, other features of the circuit structure shown in FIG. 2 are applicable to the description of FIG. 1, and thus a detailed description is deemed unnecessary.

Please refer to FIG. 3, which schematically illustrates a circuit structure and a circuit timing of an electronic device according to another embodiment of the present disclosure. As shown in the circuit structure of FIG. 3, the electronic device 1 includes a substrate 10 and a circuit unit arranged on the substrate 10. For the convenience of description, FIG. 3 is a schematic diagram showing one circuit unit of the electronic device 1, while omitting the illustration of the remaining circuit units. The circuit unit of the electronic device 1 includes an electronic component D_1, an electronic component D_2, a switch transistor TS_1, a switch transistor TS_2 and a shared electric pad 12. The electronic component D_1 and the electronic component D_2 are disposed on the substrate 10, wherein the electronic components D_1, D_2 may include passive components and/or active components, such as capacitors, resistors, inductors, diodes, transistors, ICs, other appropriate components, and circuits including the above components. The switch transistor TS_1 and the switch transistor TS_2 are disposed on the substrate 10, wherein the switch transistor TS_1 is coupled to the electronic component D_1, and the switch transistor TS_2 is coupled to the electronic component D_2. The shared electric pad 12 is disposed on the substrate 10, and is coupled to the electronic component D_1 through the switch transistor TS_1 and is coupled to the electronic component D_2 through the switch transistor TS_2. In more detail, the control end of the switch transistor TS_1 is connected to a switch signal SW_1, and the two connection ends of the switch transistor TS_1 are respectively coupled to the electronic component D_1 and the shared electric pad 12. The control end of the switch transistor TS_2 is connected to the switch signal SW_2, and the two connection ends of the switch transistor TS_2 are respectively coupled to the electronic component D_2 and the shared electric pad 12. Accordingly, since the output positions of the electronic components D_1, D_2 are separated by the switch transistors TS_1 and TS_2, the output signals may be conveniently monitored using a single shared electric pad 12, thereby optimizing the layout area and saving the test time.

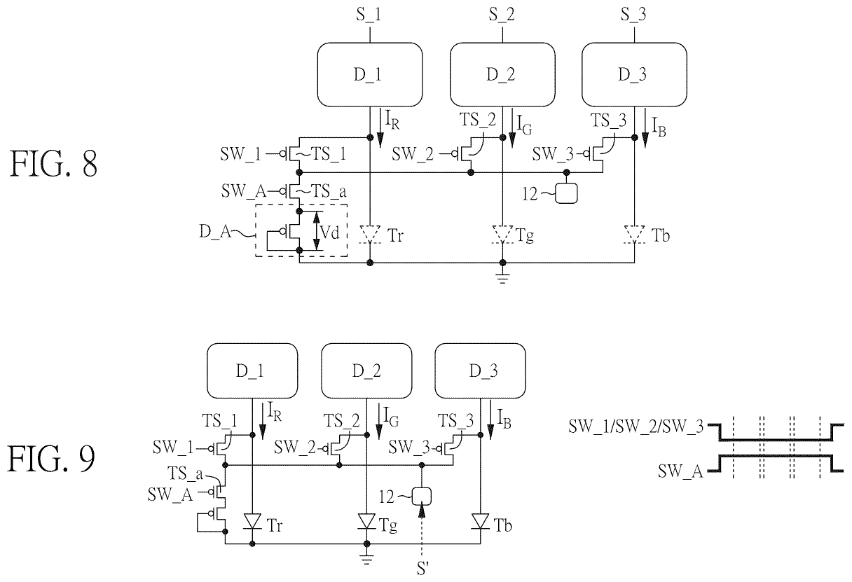

With the above circuit structure, when the switch transistor TS_1 and the switch transistor TS_2 are respectively turned on, the electrical properties of the electronic component D_1 and the electronic component D_2 can be measured respectively from the shared electric pad 12. When the switch transistor TS_1 and the switch transistor TS_2 are respectively turned off, the electrical properties of the electronic component D_1 and the electronic component D_2 cannot be measured respectively from the shared electric pad 12. For example, with reference to the circuit timing of FIG. 3, the switch transistor TS_1 and the switch transistor TS_2 are controlled to be turned on or off by the switch signal SW_1 and the switch signal SW_2, respectively. That is, in the present disclosure, the switch signal SW_1 and the switch signal SW_2 are used to control the states of the switch transistor TS_1 and the switch transistor TS_2, respectively, so as to ensure that the switch transistor TS_1 and the switch transistor TS_2 are activated during the measurement period and kept in the off state at other times. In this embodiment, since the switch transistor TS_1 and the switch transistor TS_2 are N-type transistors, when the switch signals SW_1, SW_2 are at a low level (representing logic 0, for example), the switch transistor TS_1 and the switch transistor TS_2 are turned on. Conversely, when the switch signals SW_1, SW_2 are at a high level (representing logic 1, for example), the switch transistor TS_1 and the switch transistor TS_2 are turned off. However, this is only an example but not a limitation. It is conceivable that the switch transistor TS_1 and the switch transistor TS_2 may also be P-type transistors or other suitable types of transistors. Therefore, as shown in the circuit timing of FIG. 3, during the period TP when the switch transistor TS_1 and the switch transistor TS_2 are turned on, the shared electric pad 12 is coupled to the electronic component D_1 and the electronic component D_2, respectively, and during this period TP, an input signal S_1 may be applied to the electronic component D_1 and an input signal S_2 may be applied to the electronic component D_2, wherein the input signal S_1 and the input signal S_2 do not overlap in time. Since the shared electric pad 12 is coupled to the electronic component D_1 and the electronic component D_2, respectively, when the input signal S_1 is applied to the electronic component D_1, the output of the electronic component D_1 may be obtained, and the electrical properties of the electronic component D_1 can be measured from the shared electric pad 12. When the input signal S_2 is applied to the electronic component D_2, the output of the electronic component D_2 may be obtained, and the electrical properties of the electronic component D_2 can be measured from the shared electric pad 12. When the switch transistor TS_1 and the switch transistor TS_2 are turned off, the shared electric pad 12 is not coupled to the electronic component D_1 and the electronic component D_2, so that the electrical properties of the electronic component D_1 and the electronic component D_2 cannot be measured from the shared electric pad 12. This circuit architecture may provide an optimized measurement framework, which is suitable for performing a test in contact with the shared electric pad 12, and is also suitable for performing a test without contacting the shared electric pad 12 (shown in FIG. 8), and may be applied to various types of circuits.

Furthermore, in the circuit structure of FIG. 3, the input signal S_1 and the input signal S_2 may be applied to the electronic component D_1 and the electronic component D_2 at the same time, and the switch signal SW_1 and the switch signal SW_2 may be used to control the switch transistor TS_1 and the switch transistor TS_2 to be turned on respectively during non-overlapping periods. Accordingly, when the switch signal SW_1 is used to control the switch transistor TS_1 to be turned on, the output of the electronic component D_1 may be obtained, and the electrical properties of the electronic component D_1 can be measured from the shared electric pad 12. When the switch signal SW_2 is used to control the switch transistor TS_2 to be turned on, the output of the electronic component D_2 may be obtained, and the electrical properties of the electronic component D_2 can be measured from the shared electric pad 12. When the switch signal SW_1 and the switch signal SW_2 are used to control the switch transistor TS_1 and the switch transistor TS_2 to be turned off, the shared electric pad 12 is not coupled to the electronic component D_1 and the electronic component D_2, so that the electrical properties of the electronic component D_1 and the electronic component D_2 cannot be measured from the shared electric pad 12. Therefore, the electronic components D_1, D_2 may be tested.

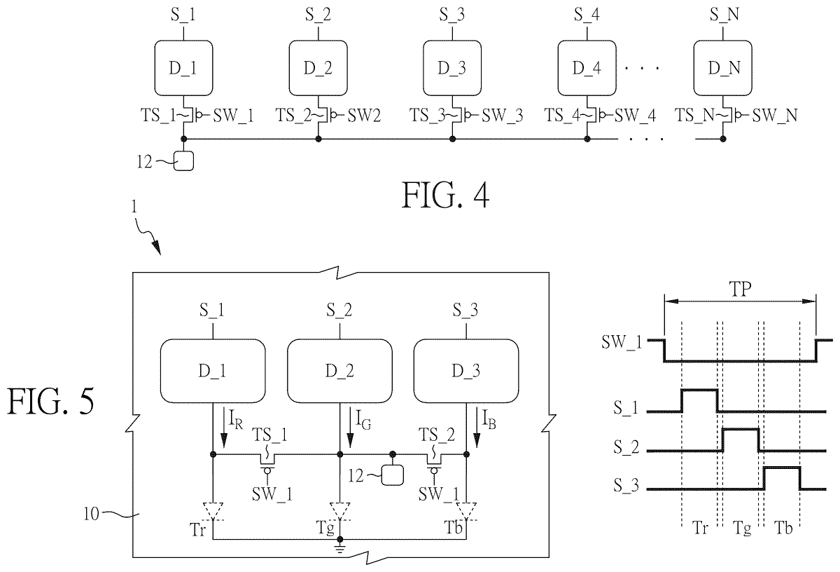

In addition, although the circuit unit shown in FIG. 3 has two electronic components D_1, D_2, the present disclosure is not limited thereto. Please refer to FIG. 4, which schematically illustrates a circuit structure of an electronic device according to another embodiment of the present disclosure, wherein the architecture of the circuit unit of the electronic device 1 in FIG. 4 is similar to that in FIG. 1, but has N electronic components D_1˜D_N and N switch transistors TS_1˜TS_N (wherein the electronic component D_1 and the electronic component D_2 of the previous embodiment may be regarded as included in the N electronic components D_1˜D_N of this embodiment, the switch transistors TS_1, TS_2 of the previous embodiment may be regarded as included in the (N−1) switch transistors TS_1˜TS_N−1 of this embodiment), where N is an integer greater than or equal to 2 (N≥2). The control ends of the N switch transistors TS_1˜TS_N are respectively connected to N switch signals SW_1˜SW_N, one connection end of the switch transistor TS_i is coupled to the electronic component D_i, and the other connection end of the switch transistor TS_i is coupled to the shared electric pad 12, wherein i is an integer and i=1˜N−1.

With the above circuit architecture, when the switch transistors TS_1˜TS_N are controlled to be turned on by the switch signals SW_1˜SW_N, the input signals S_1˜S_N may be applied to the electronic components D_1˜D_N, respectively, wherein the input signals S_1˜S_N do not overlap each other in time. When the input signal S_i is applied to the electronic component D_i, the output of the electronic component D_i may be obtained, and the electrical properties of the electronic component D_i can be measured from the shared electric pad 12, where i is an integer and i=1˜N, so that the test of the electronic components D_1˜D_N may be achieved. When the switch transistors TS_1˜TS_N are controlled to be turned off by the switch signals SW_1˜SW_N, the shared electric pad 12 is not coupled to the electronic components D_1˜D_N, so that the electrical properties of the electronic components D_1˜D_N cannot be measured from the shared electric pad 12. In addition, other features of the circuit structure shown in FIG. 4 are applicable to the description of FIG. 2, and thus a detailed description is deemed unnecessary.

Furthermore, in the circuit structure of FIG. 4, the input signals S_1 to S_N may be applied to the electronic components D_1 to D_N at the same time, and the switch signals SW_1 to SW_N may be used to control the switch transistors TS_1 to TS_N to be turned on respectively during non-overlapping periods. Accordingly, when the switch signal SW_i is used to control the switch transistor TS_i to be turned on, the output of the electronic component D_i may be obtained, and the electrical properties of the electronic component D_i can be measured from the shared electric pad 12, where i is an integer and i=1˜N. When the switch transistors TS_1˜TS_N are controlled to be turned off by the switch signals SW_1˜SW_N, the shared electric pad 12 is not coupled to the electronic components D_1˜D_N, so that the electrical properties of the electronic components D_1˜D_N cannot be measured from the shared electric pad 12. In this way, the electronic components D_1˜D_N may be tested.

Please refer to FIG. 5, which schematically illustrates a circuit structure and a circuit timing diagram of an electronic device according to another embodiment of the present disclosure. This embodiment may apply the aforementioned embodiments to an electronic device with a display panel, wherein, as shown in the circuit structure of FIG. 5, the electronic device 1 includes a substrate 10 and a circuit unit disposed on the substrate 10. For the convenience of description, FIG. 1 is a schematic diagram showing one circuit unit of the electronic device 1, while omitting the illustration of the remaining circuit units, and the circuit unit of this embodiment is, for example, a pixel unit. The circuit unit of the electronic device 1 includes an electronic component D_1, an electronic component D_2, an electronic component D_3, a switch transistor TS_1, a switch transistor TS_2 and a shared electric pad 12 disposed on the substrate 10. The electronic component D_1, the electronic component D_2, and the electronic component D_3 each may be a pixel circuit, for example, may be a red pixel circuit, a green pixel circuit and a blue pixel circuit, respectively, but the present disclosure is not limited thereto. The control ends of the switch transistors TS_1, TS_2 are each connected to the switch signal SW_1, one connection end of the switch transistor TS_1 is coupled to the electronic component D_1, the other connection end of the switch transistor TS_1 is coupled to the electronic component D_2 and the shared electric pad 12, one connection end of the switch transistor TS_2 is coupled to the electronic component D_2 and the shared electric pad 12, and the other connection end of the switch transistor TS_2 is coupled to the electronic component D_3. In addition, during the testing phase, since the pixels (for example, red pixel, green pixel, and blue pixel) corresponding to the electronic components D_1˜D_3 (for example, red pixel circuit, green pixel circuit, blue pixel circuit, etc.) have not yet been provided on the electronic device 1, in FIG. 5, dotted lines are used to represent the first semiconductor component Tr, the second semiconductor component Tg and the third semiconductor component Tb that need to be provided after the test is completed, wherein the above-mentioned components may be, for example, light emitting diodes, varactor diodes, sensing components, or suitable semiconductor components therein, but not limited thereto. In some embodiments, the first semiconductor component Tr may be, for example, a red light emitting diode, the second semiconductor component Tg may be, for example, a green light emitting diode, and the third semiconductor component Tb may be, for example, a blue light emitting diode, but the present disclosure is not limited thereto. Accordingly, since the electronic component D_1 (for example, red pixel circuit) and the electronic component D_2 (for example, green pixel circuit) share a single switch transistor TS_1, and the electronic component D_2 (for example, green pixel circuit) and the electronic component D_3 (for example, blue pixel circuit) share a single switch transistor TS_2, it is able to use two switch transistors TS_1, TS_2 and a shared electric pad 12 to monitor three electronic components D_1˜D_3, thereby optimizing the layout area.

With the above circuit architecture, please refer to the circuit timing of FIG. 5. During a period TP in which the switch signal SW_1 is used to control the switch transistor TS_1 and the switch transistor TS_2 to be turned on, the input signals S_1, S_2, S_3 may be applied to the electronic components D_1, D_2, D_3, respectively, wherein the input signals S_1, S_2, S_3 do not overlap in time. The input signals S_1, S_2, S_3 are, for example, a red pixel data signal, a green pixel data signal and a blue pixel data signal, respectively, but it is not limited thereto. When the input signal S_1 is applied to the electronic component D_1, an output I_{R} of the electronic component D_1 may be obtained, and the electrical properties of the electronic component D_1 can be measured from the shared electric pad 12. When the input signal S_2 is applied to the electronic component D_2, an output I_{G} of the electronic component D_2 may be obtained, and the electrical properties of the electronic component D_2 can be measured from the shared electric pad 12. When the input signal S_3 is applied to the electronic component D_3, an output I_{B} of the electronic component D_3 may be obtained, and the electrical properties of the electronic component D_3 can be measured from the shared electric pad 12. When the switch signal SW_1 controls the switch transistor TS_1 and the switch transistor TS_2 to be turned off, the shared electric pad 12 is not coupled to the electronic components D_1, D_3 and no input signal S_1, S_2, S_3 is applied to the electronic components D_1, D_2, D_3. Therefore, the electrical properties of the electronic components D_1, D_2, D_3 cannot be measured from the shared electric pad 12. In addition, other features of the circuit structure shown in FIG. 5 are applicable to the descriptions of FIG. 1 to FIG. 4, and thus a detailed description is deemed unnecessary.

In addition, although this embodiment is described by taking a pixel unit having three electronic components D_1, D_2, D_3 (for example, red pixel circuit, green pixel circuit, blue pixel circuit, etc.) as an example, the present disclosure is not limited thereto. For example, the pixel unit may have two electronic components (refer to the embodiment of FIG. 1), the two electronic components each may be a pixel circuit, and the two electronic components may be pixel circuits of different colors, so that the embodiment of FIG. 1 may be applied to an electronic device having a display panel. For another example, the pixel unit may have more than three electronic components (refer to the embodiment of FIG. 2), each of which may be a pixel circuit, and the more than three electronic components may be pixel circuits of different colors, so that the embodiment of FIG. 2 may be applied to an electronic device having a display panel.

Please refer to FIG. 6, which schematically illustrates a circuit structure of an electronic device according to another embodiment of the present disclosure. This embodiment is similar to the embodiment of FIG. 5, and one of the differences is that it further includes an electronic component D_A and a switch transistor TS_a, wherein the electronic component D_A is arranged on the substrate 10 and is coupled to the shared electric pad 12 through the switch transistor TS_a. In more detail, the control end of the switch transistor TS_a is connected to the switch signal SW_1, and the two connection ends of the switch transistor TS_a are respectively coupled to the shared electric pad 12 and the electronic component D_A. The electronic component D_A may be, for example, a diode, a unidirectional conductive component, or other suitable electronic components. In this embodiment, the electronic component D_A is exemplified by a diode for description, but the present invention is not limited thereto. Furthermore, by applying the input signal S_A to the electronic device D_A, it allows the shared electric pad 12 to measure electrical properties in a contact or non-contact manner. When performing contact measurement, the input signal S_A is turned off to make the diode floating, and the switch transistor TS_a is turned off to disable the electronic component D_A. Therefore, the operation of the circuit structure of FIG. 6 may be the same as that of FIG. 5 in that the electrical properties of the electronic components D_1 to D_3 are measured by contacting the shared electric pad 12. When performing non-contact measurement, the input signal S_A may be a ground signal or a low voltage signal to turn on the switch transistor TS_a. The electronic component D_A is a diode that allows current to flow to the ground end or the low voltage end. Therefore, when the input signal S_1 (or S_2, S_3) is applied to the electronic component D_1 (or D_2, D_3), the output I_{R} (or I_{G}, I_{B}) of the electronic component D_1 (or D_2, D_3) flows to the ground end or the low voltage end through the electronic component D_A. Therefore, there may be a voltage difference Vd on the electronic component D_A, and this voltage difference Vd may be sensed in a non-contact manner on the shared electric pad 12, so that the electrical properties of the electronic components D_1˜D_3 can be measured without contacting the shared electric pad 12. In addition, other features of the circuit structure shown in FIG. 6 are applicable to the descriptions of FIG. 1 to FIG. 5, and thus a detailed description is deemed unnecessary.

In addition, this embodiment is described by taking an example in which the electronic component D_A and the switch transistor TS_a are added to the embodiment of FIG. 6 so as to provide contact and non-contact measurements, but the present disclosure is not limited thereto. For example, the electronic component D_A and the switch transistor TS_a may be added to any of the embodiments of FIG. 1 to FIG. 5 in a manner similar to the present embodiment, thereby providing contact and non-contact measurements in the embodiments of FIG. 1 to FIG. 5.

Please refer to FIG. 7, which schematically illustrates a circuit structure and a circuit timing diagram of an electronic device according to another embodiment of the present disclosure. This embodiment applies the embodiments of FIG. 3 and FIG. 4 to an electronic device with a display panel, wherein, as shown in the circuit structure of FIG. 7, the electronic device 1 includes a substrate 10 and a circuit unit disposed on the substrate 10. For the convenience of description, FIG. 7 is a schematic diagram showing one circuit unit of the electronic device 1, while omitting the illustration of the remaining circuit units, and the circuit unit of this embodiment is, for example, a pixel unit. The circuit unit of the electronic device 1 includes an electronic component D_1, an electronic component D_2, an electronic component D_3, a switch transistor TS_1, a switch transistor TS_2, a switch transistor TS_3 and a shared electric pad 12 disposed on the substrate 10. The electronic component D_1, the electronic component D_2, and the electronic component D_3 are each a pixel circuit, for example, are a red pixel circuit, a green pixel circuit and a blue pixel circuit, respectively, but it is not limited thereto. The control ends of the switch transistors TS_1, TS_2, TS_3 are respectively connected to the switch signals SW_1, SW_2, SW_3, one connection end of the switch transistor TS_1 is coupled to the electronic component D_1, the other connection end of the switch transistor TS_1 is coupled to the shared electric pad 12, one connection end of the switch transistor TS_2 is coupled to the electronic component D_2, the other connection end of the switch transistor TS_2 is coupled to the shared electric pad 12, one connection end of the switch transistor TS_3 is coupled to the electronic component D_3, the other connection end of the switch transistor TS_3 is coupled to the shared electric pad 12. In addition, during the testing phase, since each pixel (for example, red pixel, green pixel and blue pixel) corresponding to the electronic components D_1˜D_3 (for example, red pixel circuit, green pixel circuit, blue pixel circuit, etc.) has not yet been provided on the electronic device 1, in FIG. 7, dotted lines are used to represent the first semiconductor component Tr, the second semiconductor component Tg, and the third semiconductor component Tb that need to be provided after the test is completed, wherein the aforementioned components may be, for example, light emitting diodes, varactor diodes, sensing components, or suitable semiconductor components therein, but it is not limited thereto. In some embodiments, the first semiconductor component Tr may be, for example, a red light emitting diode, the second semiconductor component Tg may be, for example, a green light emitting diode, and the third semiconductor component Tb may be, for example, a blue light emitting diode, but the present disclosure is not limited thereto. Accordingly, since the output positions of the electronic components D_1˜D_3 (for example, red pixel circuit, green pixel circuit, blue pixel circuit, etc.) are separated by switch transistors TS_1, TS_2, TS_3, the output signals may be conveniently monitored using a single shared electric pad 12, thereby optimizing the layout area and saving testing time.

With the above circuit architecture, please refer to the circuit timing of FIG. 7. During a period TP when the switch signals SW_1, SW_2, SW_3 are used to control the switch transistors TS_1, TS_2, TS_3 to be turned on, the input signals S_1, S_2, S_3 may be applied to the electronic components D_1, D_2, D_3, respectively, wherein the input signals S_1, S_2, S_3 do not overlap in time. The input signals S_1, S_2, S_3 are, for example, red pixel data signal, green pixel data signal, and blue pixel data signal, respectively, but it is not limited thereto. When the input signal S_1 is applied to the electronic component D_1, an output I_{R} of the electronic component D_1 may be obtained, and the electrical properties of the electronic component D_1 can be measured from the shared electric pad 12. When the input signal S_2 is applied to the electronic component D_2, an output I_{G} of the electronic component D_2 may be obtained, and the electrical properties of the electronic component D_2 can be measured from the shared electric pad 12. When the input signal S_3 is applied to the electronic component D_3, an output I_{B} of the electronic component D_3 may be obtained, and the electrical properties of the electronic component D_3 can be measured from the shared electric pad 12. When the switch signals SW_1, SW_2, SW_3 are used to control the switch transistors TS_1, TS_2, TS_3 to be turned off, the shared electric pad 12 is not coupled to the electronic components D_1, D_2, D_3, so that the electrical properties of the electronic components D_1, D_2, D_3 cannot be measured. In addition, other features of the circuit structure shown in FIG. 7 are applicable to the descriptions of FIG. 3 and FIG. 4, and thus a detailed description is deemed unnecessary.

Furthermore, in the circuit architecture of FIG. 7, the input signals S_1, S_2, S_3 may be applied to the electronic components D_1, D_2, D_3 at the same time, and the switch signals SW_1, SW_2, SW_3 may be used to control the switch transistors TS_1, TS_2, TS_3 to be turned on respectively during non-overlapping periods. Accordingly, when the switch transistor TS_1 is controlled to be turned on by the switch signal SW_1, the output of the electronic component D_1 may be obtained, and the electrical properties of the electronic component D_1 can be measured from the shared electric pad 12. When the switch transistor TS_2 is controlled to be turned on by the switch signal SW_2, the output of the electronic component D_2 may be obtained, and the electrical properties of the electronic component D_2 can be measured from the shared electric pad 12. When the switch transistor TS_3 is controlled to be turned on by the switch signal SW_3, the output of the electronic component D_3 may be obtained, and the electrical properties of the electronic component D_3 can be measured from the shared electric pad 12. When the switch transistors TS_1, TS_2, TS_3 are controlled to be turned off by the switch signals SW_1, SW_2, SW_3, the shared electric pad 12 is not coupled to the electronic components D_1, D_2, D_3, so that the electrical properties of the electronic components D_1, D_2, D_3 cannot be measured from the shared electric pad 12. In this way, the electronic components D_1, D_2, D_3 may be tested.

In addition, this embodiment is described by taking the pixel unit having three electronic components D_1, D_2, D_3 (for example, red pixel circuit, green pixel circuit, blue pixel circuit, etc.) as an example, but the present disclosure is not limited thereto. For example, the pixel unit may have two electronic components, each of which may be a pixel circuit, and the two electronic components may be pixel circuits of different colors, so that the embodiment of FIG. 3 may be applied to an electronic device having a display panel. For another example, the pixel unit may have more than three electronic components, each of which may be a pixel circuit, and the more than three electronic components may be pixel circuits of different colors, so that the embodiment of FIG. 4 may be applied to an electronic device having a display panel.

Please refer to FIG. 8, which schematically illustrates a circuit structure of an electronic device according to another embodiment of the present disclosure. This embodiment is similar to the embodiment of FIG. 7, and one of the differences is that it further includes an electronic component D_A and a switch transistor TS_a, wherein the electronic component D_A is disposed on the substrate 10 and is coupled to the shared electric pad 12 through the switch transistor TS_a. In more detail, the control end of the switch transistor TS_a is connected to the switch signal SW_A, a connection end of the switch transistor TS_a is coupled to the shared electric pad 12, the other connection end of the switch transistor TS_a is coupled to one end of the electronic component D_A, and the other end of the electronic component D_A may be grounded or provide a low voltage. The electronic component D_A may be, for example, a diode, a unidirectional conductive component, or other suitable electronic components. In this embodiment, the electronic component D_A is described by taking a diode as an example, but the present disclosure is not limited thereto. Furthermore, the arrangement of the electronic component D_A and the switch transistor TS_a allows the shared electric pad 12 to measure electrical properties in a contact or non-contact manner. When performing contact measurement, the switch signal SW_A is an OFF signal, which may turn off the switch transistor TS_a and disable the electronic component D_A. Therefore, the operation of the circuit structure of FIG. 8 is the same as that of FIG. 7 in that the electrical properties of the electronic components D_1 to D_3 are measured by contacting the shared electric pad 12. When performing non-contact measurement, the switch signal SW_A is an ON signal to turn on the switch transistor TS_a. The electronic component D_A is, for example, a diode that allows current to flow to the ground end or the low voltage end. When the input signal S_1 (or S_2, S_3) is applied to the electronic component D_1 (or D_2, D_3), the output I_{R} (or I_{G}, I_{B}) of the electronic component D_1 (or D_2, D_3) flows to the ground end or the low voltage end through the electronic component D_A. Therefore, there may be a voltage difference Vd on the electronic component D_A, and this voltage difference Vd may be sensed in a non-contact manner on the shared electric pad 12. Accordingly, the electrical properties of the electronic components D_1˜D_3 can be measured without contacting the shared electric pad 12. In addition, other features of the circuit structure shown in FIG. 8 are applicable to the description of FIG. 7, and thus a detailed description is deemed unnecessary.

In addition, this embodiment is described by taking an example in which the electronic component D_A and the switch transistor TS_a are added to the embodiment of FIG. 7 so as to provide contact and non-contact measurements, but the present disclosure is not limited thereto. For example, the electronic component D_A and the switch transistor TS_a may be added to the embodiment of FIG. 3 or the embodiment of FIG. 4 in a manner similar to this embodiment, thereby providing contact and non-contact tests in the embodiments of FIG. 3 and FIG. 4.

Please refer to FIG. 9, which schematically illustrates a circuit structure and a timing diagram of an electronic device according to another embodiment of the present disclosure. This embodiment is similar to the embodiment of FIG. 8, and one of the differences is that a first semiconductor component Tr, a second semiconductor component Tg and a third semiconductor component Tb corresponding to the electronic components D_1, D_2, D_3 (for example, red pixel circuit, green pixel circuit, blue pixel circuit, etc.) are provided on the electronic device 1, wherein the aforementioned component may be, for example, a light emitting diode, a varactor diode, a sensing component or a suitable semiconductor component therein, but it is not limited thereto. In some embodiments, the first semiconductor component Tr may be, for example, a red light emitting diode, the second semiconductor component Tg may be, for example, a green light emitting diode, and the third semiconductor component Tb may be, for example, a blue light emitting diode, but the present disclosure is not limited thereto. With this circuit structure, when testing, as shown in the timing diagram, the switch signals SW_1, SW_2, SW_3 are used to control the switch transistors TS_1, TS_2, TS_3 to be turned on, and the switch signal SW_A is used to control the switch transistor TS_a to be turned off, and no input signal is applied to the electronic components D_1, D_2, D_3, but an input signal S′ (for example, but not limited to, a current signal) is applied to the shared electric pad 12. At this moment, since the switch transistors TS_1, TS_2, TS_3 are turned on and the switch transistor TS_a is turned off, the input signal S′ may flow through and activate the first semiconductor component Tr, the second semiconductor component Tg and the third semiconductor component Tb, thereby verifying the normal operation of the pixels and identifying whether there is a potential problem caused by the external driving circuit. In addition, other features of the circuit structure shown in FIG. 9 are applicable to the description of the aforementioned embodiments, and thus a detailed description is deemed unnecessary.

In addition, this embodiment arranges the first semiconductor component Tr, the second semiconductor component Tg and the third semiconductor component Tb corresponding to the electronic components D_1, D_2, D_3 (for example, red pixel circuit, green pixel circuit, blue pixel circuit, etc.) in the embodiment of FIG. 8 to illustrate the testing of an electronic device having pixels arranged therein, but the present disclosure is not limited thereto. For example, the first semiconductor component Tr, the second semiconductor component Tg and the third semiconductor component Tb may be disposed in the embodiment of FIG. 7, and the switch transistors TS_1, TS_2, TS_3 may be controlled in a manner similar to this embodiment, so as to achieve the effect of verifying whether the pixels operate normally. For another example, the first semiconductor component Tr, the second semiconductor component Tg and the third semiconductor component Tb may be disposed in the embodiment of FIG. 6, and the switch transistors TS_1, TS_2 and the switch transistor TS_a may be controlled in a manner similar to this embodiment, so as to achieve the effect of verifying whether the pixels operate normally. For another example, the first semiconductor component Tr, the second semiconductor component Tg and the third semiconductor component Tb may be disposed in the embodiment of FIG. 5, and the switch transistors TS_1, TS_2 may be controlled in a manner similar to this embodiment, so as to achieve the effect of verifying whether the pixels operate normally. In addition, the number of pixels arranged corresponding to the pixel circuits in the aforementioned pixel unit is three, but the present disclosure is not limited thereto. In other embodiments, the number of pixels arranged corresponding to the pixel circuits may be two (for example, refer to the embodiments of FIG. 1 and FIG. 3) or may be more than three (for example, refer to the embodiments of FIG. 2 and FIG. 4).

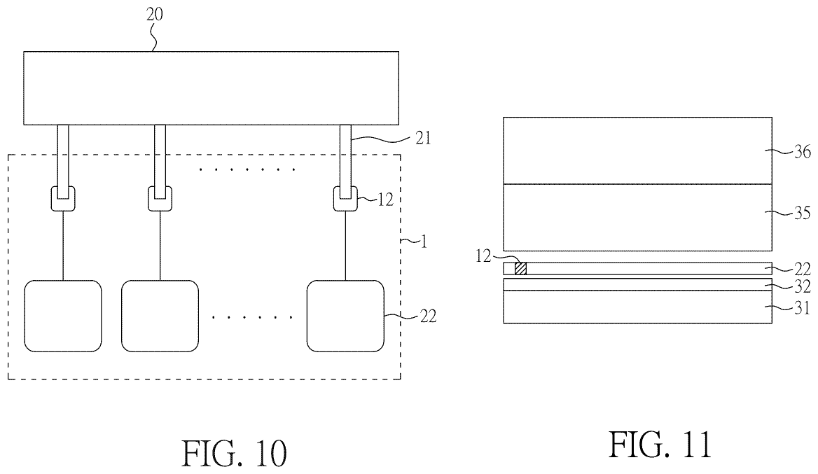

Please refer to FIG. 10, which schematically illustrates a measurement architecture of the electronic device of the present disclosure using a contact-type shared electric pad for test, wherein the electronic device 1 has a plurality of circuit units 22, each circuit unit 22 having a single shared electric pad 12. During the test, the test machine 20 uses a plurality of probes 21 to contact the plurality of shared electric pads 12, respectively, to perform electrical property measurements on the electronic component according to the aforementioned embodiments, and the test machine 20 may collect and analyze the data obtained from the measurements so as to determine whether the electronic device 1 passes the test. Furthermore, please refer to FIG. 11, which schematically illustrates a measurement architecture of the electronic device of the present disclosure using a non-contact shared electric pad for test. This measurement architecture is described by taking an electronic device having a display panel as an example, wherein the circuit unit 22 of the electronic device is placed on the backlight module 31 and the polarizing plate 32 of the test machine, and the figure schematically shows one circuit unit 22, which is for the convenience of description, but not used to limit the number of circuit units 22. When performing the tests of the aforementioned embodiments, the liquid crystal module 35 and the optical sensor 36 may be moved on the circuit unit 22 to be tested. Since the voltage difference Vd applied to the shared electric pad 12 causes the liquid crystals of the liquid crystal module 35 to be twisted, and since the voltage difference Vd may represent the electrical properties of the electronic component, the optical sensor 36 may sense, collect and analyze data based on the change in optical properties caused by the twist of the liquid crystals, thereby determining whether the electronic device 1 passes the test.

From the above description, it can be seen that the electronic device of the present disclosure may use a single shared electric pad to measure electrical properties of multiple circuit units in a contact or non-contact manner, thereby effectively optimizing the layout area, saving test time, and facilitating monitoring of output signals.

In one embodiment, the present disclosure may determine whether a product in contention falls within the protection scope of the present disclosure at least by the presence or absence of components, component configurations, mechanism observation and/or operating modes of the product, while it is not limited thereto.

The details or features of the various embodiments of the present disclosure may be mixed and matched as long as they do not violate the spirit of the invention or conflict with each other.

The aforementioned specific embodiments should be construed as merely illustrative, and not limiting the rest of the present disclosure in any way.

1. An electronic device, comprising:
a substrate;
a first electronic component and a second electronic component disposed on the substrate;
a first switch transistor disposed on the substrate and coupled to the first electronic component and the second electronic component; and
a shared electric pad disposed on the substrate and coupled to the first electronic component and the second electronic component respectively through the first switch transistor,
wherein, when the first switch transistor is turned on, electrical properties of the first electronic component and the second electronic component can be measured separately from the shared electric pad, and when the first switch transistor is turned off, electrical properties of the first electronic component and the second electronic component cannot be measured separately from the shared pad.

2. The electronic device as claimed in claim 1, wherein the first electronic component and the second electronic component are each a pixel circuit.

3. The electronic device as described in claim 1, wherein the shared electrical pad measures electrical properties in a contact or non-contact manner.

4. The electronic device as claimed in claim 1, further comprising a diode disposed on the substrate and coupled to the shared electric pad through a further switch transistor.

5. The electronic device as claimed in claim 4, wherein, when the shared electric pad measures electrical properties in a non-contact manner, the diode is grounded and the further switch transistor is turned on.

6. The electronic device as claimed in claim 4, wherein, when the shared electric pad measures electrical properties in a contact manner, the diode is floating and the further switch transistor is turned off.

7. The electronic device as claimed in claim 1, wherein, when the first switch transistor is turned on, a first input signal is applied to the first electronic component, a second input signal is applied to the second electronic component, and the first input signal and the second input signal do not overlap in time.

8. The electronic device as claimed in claim 2, further comprising semiconductor components disposed on the substrate and corresponding to the pixel circuits, wherein the first switch transistor is controlled to be turned on and an input signal is applied to the shared electric pad to activate the semiconductor components.

9. The electronic device as claimed in claim 1, wherein the electronic device includes N electronic components containing the first electronic component and the second electronic component, and (N−1) switch transistors containing the first switch transistor, where N is an integer greater than or equal to 2, an i-th switch transistor is coupled to an i-th electronic component and an (i+1)-th electronic component, where i is an integer and i=1˜(N−1), and the shared electric pad is coupled to the N electronic components respectively through the (N−1) switch transistors.

10. An electronic device, comprising:
a substrate;
a first electronic component and a second electronic component disposed on the substrate;
a first switch transistor and a second switch transistor disposed on the substrate, wherein the first switch transistor is coupled to the first electronic component, and the second switch transistor is coupled to the second electronic component; and
a shared electric pad disposed on the substrate, coupled to the first electronic component through the first switch transistor, and coupled to the second electronic component through the second switch transistor,
wherein, when the first switch transistor and the second switch transistor are respectively turned on, electrical properties of the first electronic component and the second electronic component are measured separately from the shared electric pad, and when the first switch transistor and the second switch transistor are respectively turned off, electrical properties of the first electronic component and the second electronic component cannot be measured separately from the shared electric pad.

11. The electronic device as claimed in claim 10, wherein the first electronic component and the second electronic component are each a pixel circuit.

12. The electronic device as claimed in claim 11, wherein the shared electric pad measures electrical properties in a contact manner or a non-contact manner.

13. The electronic device as claimed in claim 12, further comprising a diode disposed on the substrate and coupled to the shared electric pad through a further switch transistor.

14. The electronic device as claimed in claim 13, wherein, when the shared electric pad measures electrical properties in a non-contact manner, the further switch transistor is turned on.

15. The electronic device as claimed in claim 13, wherein, when the shared electric pad measures electrical properties in a contact manner, the further switch transistor is turned off.

16. The electronic device as claimed in claim 10, wherein, when the first switch transistor and the second switch transistor are respectively turned on, a first input signal is applied to the first electronic component, a second input signal is applied to the second electronic component, and the first input signal and the second input signal do not overlap in time.

17. The electronic device as claimed in claim 10, wherein, when a first input signal and a second input signal are applied to the first electronic component and the second electronic component, respectively, the first switch transistor and the second switch transistor are turned on respectively during non-overlapping periods.

18. The electronic device as claimed in claim 11, further comprising pixels disposed on the substrate and corresponding to the pixel circuits, wherein the first switch transistor and the second switch transistor are respectively controlled to be turned on, and an input signal is applied to the shared electric pad to enable the pixels to emit light.

19. The electronic device as claimed in claim 13, further comprising pixels disposed on the substrate and corresponding to the pixel circuits, wherein the first switch transistor and the second switch transistor are respectively controlled to be turned on, the further switch transistor is controlled to be turned off, and an input signal is applied to the shared electric pad to enable the pixels to emit light.

20. The electronic device as claimed in claim 10, wherein the electronic device includes N electronic components containing the first electronic component and the second electronic component, and N switch transistors containing the first switch transistor and the second switch transistor, where N is an integer greater than or equal to 3, one connection end of an i-th switch transistor is coupled to an i-th electronic component, and another connection end of the i-th switch transistor is coupled to the shared electric pad, where i is an integer and i=1˜N−1.
